(19) United States
(12) Patent Application Publication
(10) Pub. No.: US 2024/0253226 A1
(43) Pub. Date: Aug. 1, 2024

(54) METHOD FOR CALCULATING THE LENGTH OF WORK TRAJECTORY OF A TASK-PERFORMING ROBOT

(71) Applicant: MakinaRocks Co., Ltd., Seoul (KR)

(72) Inventors: Jeyeol LEE, Seoul (KR); Goncalves Rocha YURI, Seoul (KR); Yu Jeong JEONG, Seoul (KR)

(73) Assignee: MakinaRocks Co., Ltd., Seoul (KR)

(21) Appl. No.: 18/424,481

(22) Filed: Jan. 26, 2024

(30) Foreign Application Priority Data
Jan. 30, 2023 (KR) 10-2023-0011508
Jun. 20, 2023 (KR) 10-2023-0078800
Jun. 20, 2023 (KR) 10-2023-0078801
Aug. 8, 2023 (KR) 10-2023-0103333

(51) Int. Cl. B25J 9/16; B25J 9/02

(52) U.S. Cl. CPC B25J 9/1664; B25J 9/023; B25J 9/163

(57) ABSTRACT

Disclosed is a method for calculating a work trajectory of a task-performing robot, the method performed by one or more processor of a computing device. The method may include: determining available work points of a task-performing robot; generating plurality of candidate work trajectories for the task-performing robot based on the determined available work points; and predicting a distance between the determined available work points based on the generated plurality of candidate work trajectories in order to distribute a target work point to the task-performing robot.

### CROSS-REFERENCE TO RELATED APPLICATIONS

This application claims priority to and the benefit of Korean Patent Application No. 10-2023-0011508 filed in the Korean Intellectual Property Office on Jan. 30, 2023; Korean Patent Application No. 10-2023-0078800 filed in the Korean Intellectual Property Office on Jun. 20, 2023; Korean Patent Application No. 10-2023-0078801 filed in the Korean Intellectual Property Office on Jun. 20, 2023; and Korean Patent Application No. 10-2023-0103333 filed in the Korean Intellectual Property Office on Aug. 8, 2023, the entire contents of which are incorporated herein by reference.

### TECHNICAL FIELD

The present disclosure relates to a method for calculating the length of a work trajectory of a task-performing robot, and more particularly, to a method for calculating the length of a work trajectory of a task-performing robot in order to distribute a target work point to the task-performing robot.

### BACKGROUND ART

When welding points are distributed to a robot, the corresponding robot visits all distributed welding points. In this case, it should be determined which order to visit, which belongs to a traveling salesman problem (TSP) as a problem of finding an order to visit all welding points at a shortest distance. When it is assumed that up to approximately 20 welding points can be distributed to one robot, if all distances between pairs of the robot and available work points are known, a visitation order may be easily determined by using a tsp solver which is already present. However, a length of a trajectory in which the robot actually moves between two welding points cannot be known until planning is conducted, and it takes a long time to know in advance all distances between the pairs of the robot and the available work points by the planning beyond a realistic possibility Accordingly, a method is required, which can estimate the length between the pairs of the robot and the available work point without planning.

In general, a method therefor could adopt directly using a Euclidean distance. However, the Euclidean distance cannot normally reflect an actual movement of the robot, due to a joint limit of an actual robot, presence of an obstacle, etc., and when only the Euclidean distance is used, a trajectory in which the actual robot goes a long way back is expressed as a very short trajectory, so the visitation order can be determined, and furthermore, it is determined that a trajectory planned in the visitation order is short, so an incorrect distribution can be made, and this can significantly reduce an effect of off-line programming (OLP) automation.

Therefore, there is a need for a method which can reflect the actual movement of the robot, and estimate the length between the pairs of the robot and the available work point without overall planning.

On the other hand, the present disclosure has been derived at least based on the technical background described above, but the technical problem or object of the present disclosure is not limited to solving the problems or disadvantages described above. That is, the present disclosure may cover various technical issues related to the content to be described below, in addition to the technical issues discussed above.

### SUMMARY OF THE INVENTION

The present disclosure has been made in an effort to calculate a work trajectory of a task-performing robot in order to distribute a target work point to the task-performing robot.

Meanwhile, a technical object to be achieved by the present disclosure is not limited to the above-mentioned technical object, and various technical objects can be included within the scope which is apparent to those skilled in the art from contents to be described below.

An exemplary embodiment of the present disclosure provides a method performed by a computing device. The method may include: determining available work points of a task-performing robot; generating a plurality of candidate work trajectories for the task-performing robot based on the determined available work points; and predicting a distance between the determined available work points based on the generated plurality of candidate work trajectories in order to distribute a target work point to the task-performing robot.

Alternatively, the determining of the available work points of the task-performing robot may include determining the available work points based on at least one of a posture, a position, or an entry of the task-performing robot.

Alternatively, the task-performing robot may include a task-performing part, and the generating of the plurality of candidate work trajectories for the task-performing robot based on the determined available work points may include modeling the task-performing part, and generating the plurality of candidate work trajectories for the task-performing robot based on the modeled task-performing part and the determined available work points.

Alternatively, the generating of the plurality of candidate work trajectories for the task-performing robot based on the modeled task-performing part and the determined available work points may further include predicting one or more impossible work trajectories among the generated plurality of candidate work trajectories based on the modeled task-performing part and obstacle information, and generating a modified work trajectory for the predicted impossible work trajectory.

Alternatively, the generating of the plurality of candidate work trajectories for the task-performing robot based on the determined available work points may include estimating whether a Cartesian move of the task-performing robot is possible for any two points of the determined available work points, and generating a plurality of candidate work trajectories for the task-performing robot based on whether the Cartesian move is possible.

Alternatively, the estimating of whether the Cartesian move of the task-performing robot is possible for any two points of the determined available work points may include estimating whether the task-performing robot is possible to linearly move in front/rear, up/down, or left/right directions for any two points among the determined available work points.

Alternatively, the generating of the plurality of candidate work trajectories for the task-performing robot based on the determined available work points may include disregarding the obstacle information, and generating an interpolated trajectory of the task-performing robot for any two points among the determined available work points, and generating the plurality of candidate work trajectories for the task-performing robot based on the generated interpolated trajectory.

Alternatively, the target work point may mean a point at which the task-performing robot actually performs work among the determined available work points.

Another exemplary embodiment of the present disclosure provides a computer program stored in a computer-readable storage medium. When the computer program is executed by one or more processors, the computer program may allow the one or more processors to perform operations for calculating a work trajectory of a task-performing robot, and the operations may include: an operation of determining available work points of a task-performing robot; operation of generating a plurality of candidate work trajectories for the task-performing robot based on the determined available work points; and operation of predicting a distance between the determined available work points based on the generated plurality of candidate work trajectories in order to distribute a target work point to the task-performing robot.

Still another exemplary embodiment of the present disclosure provides a computing device. The device may include: at least one processor; and a memory, and the processor may be configured to determine available work points of a task-performing robot; generate a plurality of candidate work trajectories for the task-performing robot based on the determined available work points; and predict a distance between the determined available work points based on the generated plurality of candidate work trajectories in order to distribute a target work point to the task-performing robot.

According to an exemplary embodiment of the present disclosure, the length of a work trajectory of a task-performing robot can be calculated in order to distribute a target work point to the task-performing robot.

Meanwhile, the effects of the present disclosure are not limited to the above-mentioned effects, and various effects can be included within the scope which is apparent to those skilled in the art from contents to be described below.

### BRIEF DESCRIPTION OF THE DRAWINGS

FIG. 1 is a block diagram of a computing device for calculating a work trajectory of a task-performing robot according to an exemplary embodiment of the present disclosure.

FIG. 2 is a schematic view illustrating a network function according to an exemplary embodiment of the present disclosure.

FIG. 3 is a flowchart illustrating a method for calculating a work trajectory of a task-performing robot according to an exemplary embodiment of the present disclosure.

FIG. 4 is a schematic view for describing a process of determining available work points for the task-performing robot according to an exemplary embodiment of the present disclosure.

FIG. 5A is a schematic view for describing a process of modeling a task-performing part according to an exemplary embodiment of the present disclosure.

FIG. 5B is a schematic view for describing a process of generating a plurality of candidate work trajectories for the task-performing robot based on the modeled task-performing part and the determined available work points according to an exemplary embodiment of the present disclosure.

FIG. 6 is a schematic view illustrating a process of estimating whether Cartesian move of the task-performing robot is possible for any two points of the determined available work points, and generating a plurality of candidate work trajectories for the task-performing robot based on whether the Cartesian move is possible, according to the exemplary embodiment of the present disclosure.

FIG. 7 is a schematic view illustrating a process of disregarding obstacle information, and generating an interpolated trajectory of the task-performing robot for any two points of the determined available work points according to an exemplary embodiment of the present disclosure.

FIG. 8 is a schematic view for describing a process of predicting a distance between the determined available work points based on the generated plurality of candidate work trajectories according to an exemplary embodiment of the present disclosure.

FIG. 9 is a normal and schematic view of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components.

One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally In terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, a network function and an artificial neural network and a neural network may be interchangeably used.

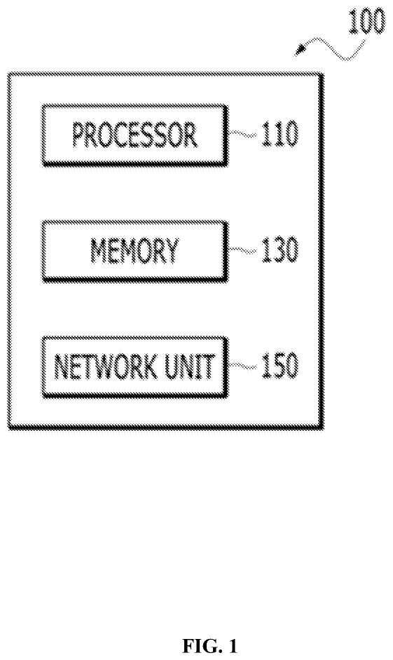

FIG. 1 is a block diagram of a computing device for calculating a work trajectory of a task-performing robot according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for training the neural network. At least one of the CPU, GPGPU, and TPU of the processor 110 may process training of a network function. For example, both the CPU and the GPGPU may process the training of the network function and data classification using the network function. Further, in an exemplary embodiment of the present disclosure, processors of a plurality of computing devices may be used together to process the training of the network function and the data classification using the network function. Further, the computer program executed in the computing device according to an exemplary embodiment of the present disclosure may be a CPU, GPGPU, or TPU executable program.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to an exemplary embodiment of the present disclosure may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network unit 150 presented in the present disclosure may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

In the present disclosure, the network unit 150 may be configured regardless of communication modes such as wired and wireless modes and constituted by various communication networks including a personal area network (PAN), a wide area network (WAN), and the like. Further, the network may be known World Wide Web (WWW) and may adopt a wireless transmission technology used for short-distance communication, such as infrared data association (IrDA) or Bluetooth. The techniques described in the present disclosure may also be used in other networks mentioned above.

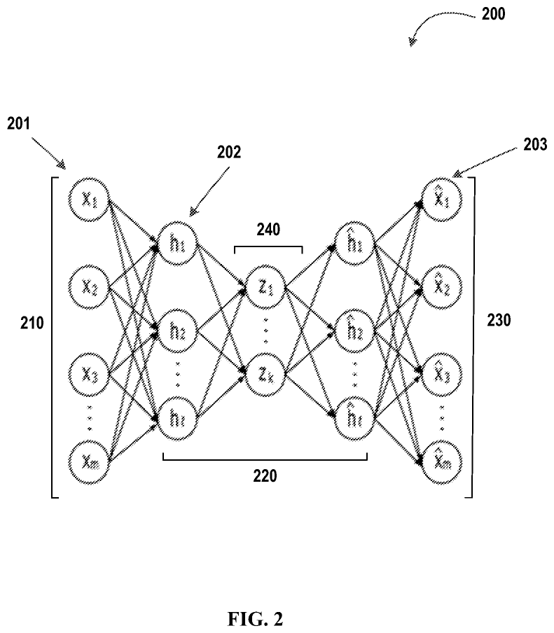

FIG. 2 is a conceptual view illustrating a neural network 200 according to an exemplary embodiment of the present disclosure.

A neural network model according to the exemplary embodiment of the present disclosure may include a neural network for evaluating placement of the semiconductor device. Throughout the present specification, a computation model, the neural network, a network function, and the neural network may be used as the same meaning. The neural network 200 may be generally constituted by an aggregate of calculation units which are mutually connected to each other, which may be called nodes. The nodes may also be called neurons. The neural network 200 is configured to include one or more nodes. The nodes (alternatively, neurons) constituting the neural networks may be connected to each other by one or more links.

In the neural network 200, one or more nodes connected through the link may relatively form the relationship between an input node 201 and an output node 203. Concepts of the input node and the output node are relative and a predetermined node which has the output node relationship with respect to one node may have the input node relationship in the relationship with another node and vice versa. As described above, the relationship of the input node 201 to the output node 203 may be generated based on the link. One or more output nodes 203 may be connected to one input node 201 through the link and vice versa.

In the relationship of the input node 201 and the output node 203 connected through one link, a value of data of the output node 203 may be determined based on data input in the input node 201. Here, a link connecting the input node 201 and the output node 203 to each other may have a weight. The weight may be variable and the weight is variable by a user or an algorithm in order for the neural network 200 to perform a desired function. For example, when one or more input nodes 201 are mutually connected to one output node 203 by the respective links, the output node 203 may determine an output node value based on values input in the input nodes 201 connected with the output node 203 and the weights set in the links corresponding to the respective input nodes 201.

As described above, in the neural network 200, one or more nodes are connected to each other through one or more links to form a relationship of the input node 201 and output node 203 in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node 201 is n may constitute n layers. The distance from the initial input node 201 may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node 203.

The initial input node 201 may mean one or more nodes in which data is directly input without passing through the links in the relationships with other nodes among the nodes in the neural network. Alternatively, in the neural network, in the relationship between the nodes based on the link, the initial input node 201 may mean nodes which do not have other input nodes 201 connected through the links. Similarly thereto, the final output node 203 may mean one or more nodes which do not have the output node 203 in the relationship with other nodes among the nodes in the neural network. Further, a hidden node 202 may mean nodes constituting the neural network other than the initial input node 201 and the final output node 203.

In the neural network according to an exemplary embodiment of the present disclosure, the number of nodes of the input layer 210 may be the same as the number of nodes of the output layer 230, and the neural network may be a neural network of a type in which the number of nodes decreases and then, increases again from the input layer 210 to the hidden layer 220. Further, in the neural network according to another exemplary embodiment of the present disclosure, the number of nodes of the input layer 210 may be smaller than the number of nodes of the output layer 230, and the neural network may be a neural network of a type in which the number of nodes decreases from the input layer 210 to the hidden layer 220. Further, in the neural network according to yet another exemplary embodiment of the present disclosure, the number of nodes of the input layer 210 may be larger than the number of nodes of the output layer 230, and the neural network may be a neural network of a type in which the number of nodes increases from the input layer 210 to the hidden layer 220. The neural network according to still yet another exemplary embodiment of the present disclosure may be a neural network of a type in which the neural networks are combined.

A deep neural network (DNN) may refer to a neural network that includes a plurality of hidden layers in addition to the input 210 and output layers 230. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer 220 and odd hidden layers 220 may be disposed between the input and output layers. The number of nodes in each layer may be reduced from the number of nodes in the input layer to an intermediate layer called a bottleneck layer 240 (encoding), and then expanded symmetrical to reduction to the output layer 230 (symmetrical to the input layer) in the bottleneck layer 240. The auto encoder may perform non-linear dimensional reduction. The number of input 210 and output layers 230 may correspond to a dimension after preprocessing the input data. The auto encoder structure may have a structure in which the number of nodes in the hidden layer 220 included in the encoder decreases as a distance from the input layer 210 increases. When the number of nodes in the bottleneck layer 240 (a layer having a smallest number of nodes positioned between an encoder and a decoder) is too small, a sufficient amount of information may not be delivered, and as a result, the number of nodes in the bottleneck layer 240 may be maintained to be a specific number or more (e.g., half of the input layers or more).

The neural network 200 may be trained in at least one scheme of supervised learning, unsupervised learning, semi supervised learning, or reinforcement learning. The learning of the neural network 200 may be a process in which the neural network 200 applies knowledge for performing a specific operation to the neural network 200.

The neural network 200 may be trained in a direction to minimize errors of an output. The training of the neural network 200 is a process of repeatedly inputting training data into the neural network 200 and calculating the output of the neural network 200 for the training data and the error of a target and back-propagating the errors of the neural network 200 from the output layer 230 of the neural network 200 toward the input layer 210 in a direction to reduce the errors to update the weight of each node of the neural network 200. In the case of the supervised learning, the training data labeled with a correct answer is used for each training data (i.e., the labeled training data) and in the case of the unsupervised learning, the correct answer may not be labeled in each training data. That is, for example, the training data in the case of the supervised learning related to the data classification may be data in which category is labeled in each training data. The labeled training data is input to the neural network 200, and the error may be calculated by comparing the output (category) of the neural network 200 with the label of the training data. As another example, in the case of the unsupervised learning related to the data classification, the training data as the input is compared with the output of the neural network 200 to calculate the error. The calculated error is back-propagated in a reverse direction (i.e., a direction from the output layer 230 toward the input layer 210) in the neural network 200 and connection weights of respective nodes of each layer of the neural network 200 may be updated according to the back propagation. A variation amount of the updated connection weight of each node may be determined according to a learning rate. Calculation of the neural network for the input data and the back-propagation of the error may constitute a training cycle (epoch). The learning rate may be applied differently according to the number of repetition times of the training cycle of the neural network 200. For example, in an initial stage of the training of the neural network 200, the neural network 200 ensures a certain level of performance quickly by using a high learning rate, thereby increasing efficiency and uses a low learning rate in a latter stage of the training, thereby increasing accuracy.

In training of the neural network 200, the training data may be generally a subset of actual data (i.e., data to be processed using the trained neural network 200), and as a result, there may be a training cycle in which errors for the training data decrease, but the errors for the actual data increase. Overfitting is a phenomenon in which the errors for the actual data increase due to excessive training of the training data. For example, a phenomenon in which the neural network 200 that trains a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the training data, regularization, dropout of omitting a part of the node of the network 200 in the process of training, utilization of a batch normalization layer, etc., may be applied.

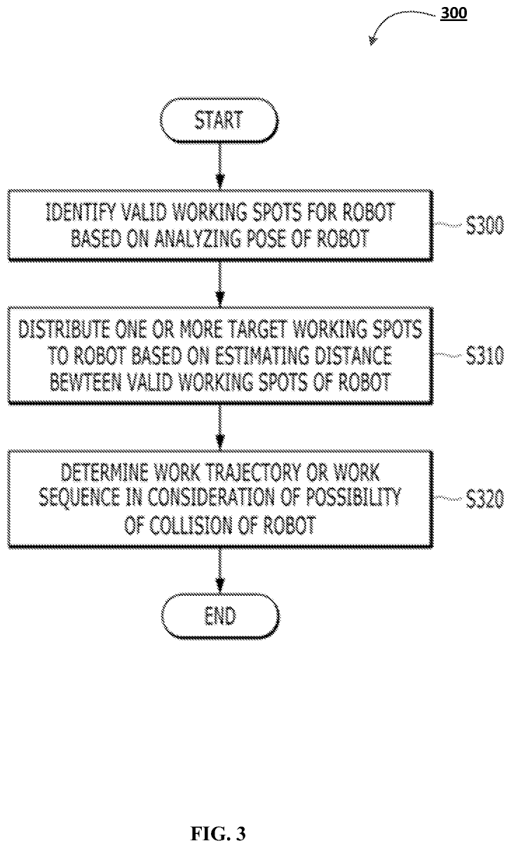

FIG. 3 is a flowchart illustrating a method 300 for calculating a work trajectory of a task-performing robot according to an exemplary embodiment of the present disclosure.

A computing device 100 according to an exemplary embodiment of the present disclosure may directly acquire or receive, from an external system, “work information for calculating a work trajectory of a task-performing robot”. The external system may be a server or database that stores and manages the work information for calculating the work trajectory of the task-performing robot. The computing device 100 may use the work information acquired directly or received from the external system as “input data for calculating the work trajectory of the task-performing robot”.

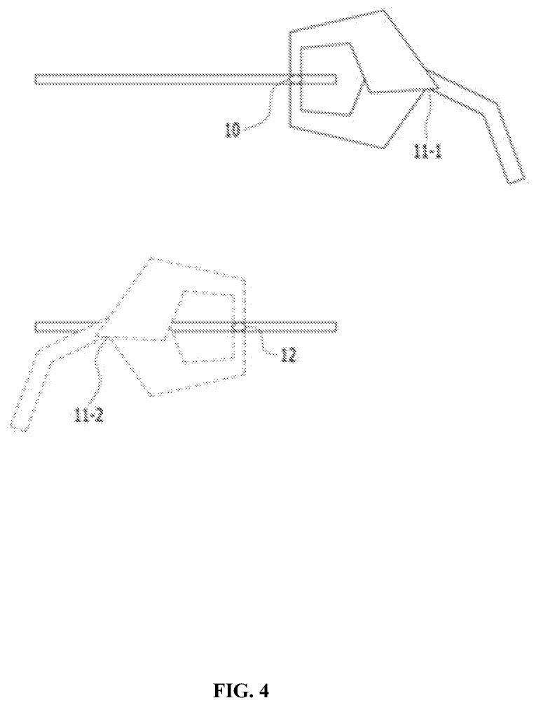

The computing device 100 may determine available work points for the task-performing robot (S110). For example, the computing device 100 may determine the available work points based on at least one of a posture, a position, or entry of the task-performing robot. Specifically, the computing device 100 may determine available work points at which a specific task-performing robot is capable of performing work based on at least one of the posture, the position, or the entry of the task-performing robot among the work points, and store the specific task-performing robot and the available work points as a data pair. A detailed description thereof will be described below with reference to FIG. 4 below.

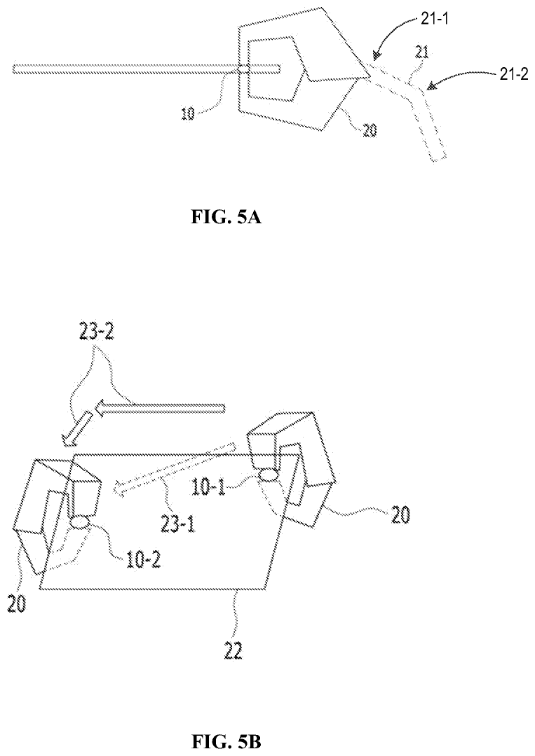

The computing device 100 may generate a plurality of work trajectories for the task-performing robot based on the available work points determined through step S110 (S120). In this case, the task-performing robot may include a task-performing part, a robot arm, a joint, etc. For example, the computing device 100 may model the task-performing part, and generate the plurality of candidate work trajectories for the task-performing robot based on the modeled task-performing part and the determined available work points. Specifically, the computing device 100 may predict one or more impossible work trajectories among the generated plurality of candidate work trajectories based on the modeled task-performing part and the obstacle information, and generate a modified work trajectory for the predicted impossible work trajectory. A length of a trajectory in which the task-performing robot moves between work points may not be known until planning is actually conducted, but the computing device 100 models the task-performing part included in the task-performing robot, and generates the plurality of candidate work trajectory by using only the modeled task-performing part to generate an approximated trajectory without planning a trajectory of the entire task-performing robot. For example, since the entire task-performing robot is also impossible to move when the modeled task-performing part is impossible to move, the impossible work trajectory is predicted based on the task-performing part and the obstacle information to reduce a search space of the work trajectory. A specific process of modeling the task-performing part, and generating the plurality of candidate work trajectories for the task-performing robot based on the modeled task-performing part and the determined available work points will be described below through FIGS. 5A and 5B below.

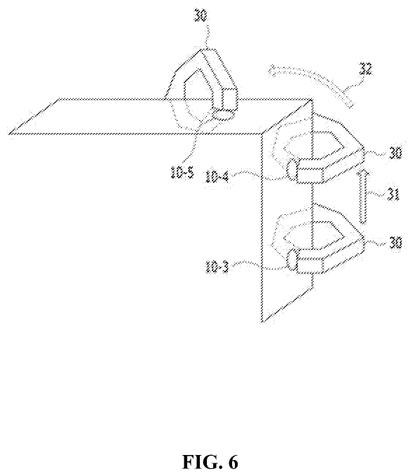

According to another exemplary embodiment of the present disclosure, the computing device 100 may estimate whether Cartesian move of the task-performing robot is possible for any two points of the determined available work points, and generate a plurality of candidate work trajectories for the task-performing robot based on whether the Cartesian move is possible. Specifically, the computing device 100 may estimate whether the task-performing robot is possible to linearly move in front/rear, up/down, or left/right directions for any two points among the determined available work points. In this case, the Cartesian move may be a linear movement of the task-performing robot in the front/rear, up/down, or left/right directions for any two points among the determined available work points, and may mean a movement in which the task-performing robot moves in 3 motion axes of x, y, and z. Meanwhile, in the case where the computing device 100 estimates whether the task-performing robot is possible to Cartesian-move for any two points among the determined available work points, a length of an entire trajectory of the task-performing robot may be efficiently calculated as compared with planning, and if the task-performing robot is possible to a Cartesian-move for any two points among the determined available work points, it may be estimated that “a distance of a trajectory between two available work points” will be in proportion to the Euclidian distance. A specific process of estimating whether Cartesian move of the task-performing robot is possible for any two points of the determined available work points, and generating a plurality of candidate work trajectories for the task-performing robot based on whether the Cartesian move is possible, which is estimated will be described below through FIG. 6 below.

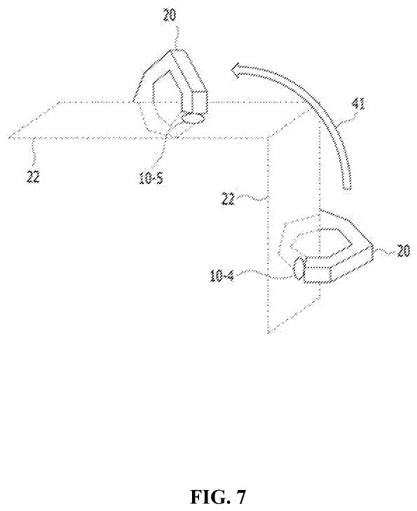

According to still another exemplary embodiment of the present disclosure, the computing device 100 may disregard the obstacle information, generate an interpolated trajectory of the task-performing robot for any two points among the determined available work points, and generate the plurality of candidate work trajectories for the task-performing robot based on the generated interpolated trajectory. In this case, the interpolated trajectory may mean a trajectory in which the obstacle information is disregarded for any two points among the determined available work points, and a rotating operation and a joint limit of the task-performing robot are considered. Further, in the interpolated trajectory, the rotating operation and the joint limit of the task-performing robot may be considered, so when “a distance of a trajectory between two available work points which are close or spaced by an intermediate distance” is predicted, the distance may be predicted more accurately than the Euclidian distance. A specific process in which the obstacle information is disregarded for any two points among the determined available work points, and the interpolated trajectory of the task-performing robot is generated will be described below through FIG. 7 below.

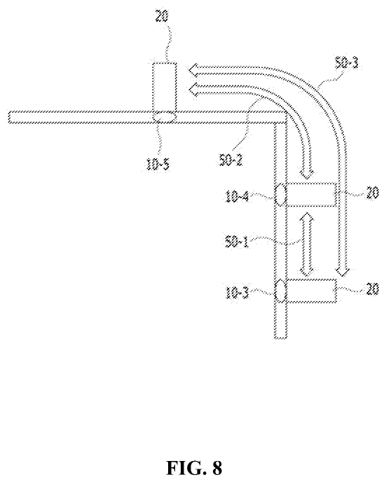

The computing device 100 may predict the distance between the available work points determined through step S110 based on the plurality of candidate work trajectories generated through step S120 in order to distribute the target work point to the task-performing robot (S130). In this case, the target work point may mean a point at which the task-performing robot actually performs the work among the determined available work points. Meanwhile, when the target work points are distributed to the task-performing robot, in which order the work should be performed for the target work point should be determined, and this belongs to a traveling salesman problem (TSP) which is a problem of finding an order to visit all target work points at a shortest distance. Further, the computing device 100 should know a distance between the work points in order to determine a visitation order for the target work point by using a TSP solver which is already present as a known technology in order to solve the traveling salesman problem (TSP). In this case, the computing device 100 may predict the distance between the available work points determined based on the generated plurality of candidate work trajectories, and easily determine a visitation order between the determined available work points by using the TSP solver which is already present based on the predicted distance. A specific process of predicting the distance between the available work points determined based on the generated plurality of candidate work trajectories will be described below in FIG. 8 below.

FIG. 4 is a schematic view for describing a process of determining available work points for the task-performing robot according to an exemplary embodiment of the present disclosure.

The computing device 100 may determine available work points 10 where the work is possible based on at least one of the posture, the position, or the entry of the task-performing robot among the work points. For example, the task-performing robot may include a robot that performs welding, and work points may include welding points. In this case, referring to FIG. 4, when the work point is a position of a first welding point 10, the task-performing robot is capable of entering up to the first welding point 10 at a workable posture 11-1, and may be present at a position at which the working is possible with respect to the first welding point 10, so the first welding point 10 may be determined as the available work point. On the contrary, when the work point is a position of a second welding point 12, there is no posture of the task-performing robot capable of performing the work (11-2), the task-performing robot is incapable of entering up to the second welding point 12, and there is no position at which the work is possible with respect to the second welding point 12, so the second welding point 12 may be not determined as the available work point. Additionally, there may be a limit in length or rotation in a robot arm and a robot joint of the task-performing robot. Therefore, even when the welding points 10 and 12 are too distant from the task-performing robot, it is impossible to perform the work, so the welding points 10 and 12 may be not determined as the available work points.

Meanwhile, according to an exemplary embodiment of the present disclosure, the computing device 100 determines “available work points 10 at which the task-performing robot is capable of performing the work among the work points” based on at least one of the posture, the position, or the entry of the task-performing robot to reduce an input space and a search space when calculating the work trajectory of the task-performing robot. However, the welding points 10 and 12 are just an example for describing the available work points, which are not limited to the welding point, and points at which various works are performed may be included in the available work points.

A process of modeling the task-performing part of the task-performing robot, and generating the plurality of candidate work trajectories for the task-performing robot based on the modeled task-performing part and the determined available work points will be described below through FIGS. 5A and 5B below.

FIG. 5A is a schematic view for describing a process of modeling a task-performing part according to an exemplary embodiment of the present disclosure.

Referring to FIG. 5A, the task-performing robot may include a task-performing part 20, a robot arm 21-1, a joint 21-2, etc., and the computing device 100 may model the task-performing part 20. For example, when the task-performing robot is a robot that performs welding, the computing device 100 may model a mesh of a welding gun which is the task-performing part 20. Further, the computing device 100 may use the modeled task-performing part 20 for generating an approximated trajectory of the trajectory of the entire task-performing robot. A length of a trajectory in which the task-performing robot moves between two work points may not be known until planning is actually conducted, but when the computing device 100 models the entire task-performing robot including both the robot arm 21-1 and the joint 21-2, and plans all work trajectories of the modeled entire task-performing robot, a computational amount significantly increases. Accordingly, the approximated trajectory is generated by using only the modeled task-performing part 20 to reduce the computational amount.

Meanwhile, FIG. 5B is a schematic view for describing a process of generating a plurality of candidate work trajectories for the task-performing robot based on the modeled task-performing part and the determined available work points according to an exemplary embodiment of the present disclosure.

The computing device 100 may generate a plurality of candidate work trajectories 23-1 and 23-2 for the task-performing robot based on the modeled task-performing part 20 and the determined available work points 10-1 and 10-2. Further, the computing device 100 may predict one or more impossible work trajectories 23-1 among the generated plurality of candidate work trajectories based on the modeled task-performing part 20 and obstacle information 22, and generate a modified work trajectory 23-2 for the predicted impossible work trajectory 23-1. For example, in FIG. 5B, the computing device 100 may generate, as a candidate work trajectory, a trajectory in which the modeled task-performing part 20 moves between a first available work point 10-1 and a second available work point 10-2. Additionally, the computing device 100 may predict the generated candidate work trajectory 23-1 as the impossible work trajectory 23-1 because the modeled task-performing part 20 may not move along the generated candidate work trajectory 23-1 due to the obstacle information 22. Meanwhile, since the entire task-performing robot is also impossible to move along the generated candidate work trajectory 23-1 when the modeled task-performing part 20 is impossible to move along the generated candidate work trajectory 23-1, the computing device 100 may reduce the search space of the work trajectory by predicting the impossible work trajectory 23-1 among the generated plurality of candidate work trajectories based on the task-performing part 20 and the obstacle information 22. Additionally, the computing device 100 may generate a modified work trajectory 23-2 so that the modeled task-performing part 20 may move between the first available work point 10-1 and the second available work point 10-2 without being affected by the obstacle information 22 for the predicted impossible work trajectory 23-1. For example, the computing device 100 may determine any collision avoidance point (for example, a point outside an obstacle) so that the modeled task-performing part 20 is not affected by the obstacle information 22, and generate the modified work trajectory 23-2 in which the modeled task-performing part 20 passes through “the first available work point 10-1→the collision avoidance point→the second available work point 10-2”. Meanwhile, in FIG. 5B, the generated candidate work trajectory, the predicted impossible work trajectory 23-1 or the modified work trajectory 23-2 are just examples, and various trajectories may be generated, and a plurality of trajectories may be generated in addition to a single trajectory. Meanwhile, the modeled task-performing part 20 may be used in the process of generating the interpolated trajectory of the task-performing robot according to other exemplary embodiments of the present disclosure, and a specific process thereof will be described below through FIGS. 6 to 7 below.

FIG. 6 is a schematic view illustrating a process of estimating whether a Cartesian move of the task-performing robot is possible for any two points of the determined available work points, and generating a plurality of candidate work trajectories for the task-performing robot based on whether the Cartesian move is possible, which is estimated according to the exemplary embodiment of the present disclosure.

The computing device 100 may estimate whether the Cartesian move of the task-performing robot 30 is possible for any two points of the determined available work points 10-3, 10-4, and 10-5, and generate a plurality of candidate work trajectories for the task-performing robot 30 based on whether the Cartesian move is possible, which is estimated. In this case, in the Cartesian move, the task-performing robot 30 may move in the front/rear, up/down, or left/right directions for any two points 10-3 and 10-4 among the determined available work points 10-3, 10-4, and 10-5, and the Cartesian move may mean a movement in which the task-performing robot moves in 3 motion axes of x, y, and z. For example, the task-performing robot 30 which moves between a third available work point 10-3 and a fourth available work point 10-4 in FIG. 6 moves only in the up/down direction to move between two available work points 10-3 and 10-4. Accordingly, the computing device 100 may estimate that the Cartesian move of the task-performing robot is possible for the third available work point 10-3 and the fourth available work point 10-4, and generate, as the candidate work trajectory 31, a trajectory of the task-performing robot 30 which moves between the third available work point 10-3 and the fourth available work point 10-4. On the contrary, the task-performing robot 30 which moves between the fourth available work point 10-4 and a fifth available work point 10-5 in FIG. 6 moves only in the front/rear, up/down, or left/right directions, so the task-performing robot 30 may not move between two available work points 10-4 and 10-5. Accordingly, the computing device 100 may estimate that the Cartesian move of the task-performing robot is impossible for the fourth available work point 10-4 and the fifth available work point 10-5, and a trajectory 32 of the task-performing robot 30 which moves between the fourth available work point 10-4 and the fifth available work point 10-5 may not be generated as “a candidate work trajectory in which the Cartesian move is possible”. Meanwhile, in the case where the computing device 100 estimates whether the task-performing robot is possible to Cartesian-move for any two points among the determined available work points 10-3, 10-4, and 10-5, the trajectory of the task-performing robot may be efficiently calculated as compared with planning, and if the task-performing robot 30 is possible to Cartesian-move for any two points among the determined available work points, it may be estimated that “a distance of a trajectory between two available work points 10-3 and 10-4” will be in proportion to the Euclidian distance. Accordingly, when the distance of the candidate work trajectory 31 in which the Cartesian move is possible is predicted, the Euclidian distance may be used, which may be calculated more easily than a case where the trajectory of the task-performing robot is planned, so the distance of the trajectory for the candidate work trajectory 31 in which the Cartesian move is possible may be easily predicted. Meanwhile, a trajectory 32 of the task-performing robot 30 which moves between the fourth available work point 10-4 and the fifth available work point 10-5 may be generated as the candidate work trajectory through other exemplary embodiments (for example, the process of generating the interpolated trajectory) of the present disclosure, and a specific process will be described below through FIG. 7 below.

FIG. 7 is a schematic view illustrating a process of disregarding obstacle information, and generating an interpolated trajectory of the task-performing robot for any two points of the determined available work points according to an exemplary embodiment of the present disclosure.

According to yet another exemplary embodiment of the present disclosure, the computing device 100 may disregard the obstacle information 22, generate an interpolated trajectory 41 of the task-performing robot for any two points 10-4 and 10-5 among the determined available work points, and generate the plurality of candidate work trajectories for the task-performing robot based on the generated interpolated trajectory 41. In this case, the interpolated trajectory 41 may mean a trajectory in which the obstacle information 22 is disregarded for any two points 10-4 and 10-5 among the determined available work points, and a rotating operation and a joint limit of the task-performing robot are considered. For example, in FIG. 7, the rotating operation is particularly required for the task-performing part 20 to move between the fourth available work point 10-4 and the fifth available work point 10-5. Additionally, when the computing device 100 considers even the obstacle information 22 at the time of generating the trajectory in which the task-performing part 20 moves between the fourth available work point 10-4 and the fifth available work point 10-5, a step of generating and modifying the trajectory through the planning by the computing device 100 as in the example of FIG. 5B is required. In order to solve this, in the exemplary embodiment of FIG. 7, the computing device 100 disregards the obstacle information 22, and compares “a posture or a position of the task-performing part 20 in the fourth available work point 10-4” and “a posture or a position of the task-performing part 20 in the fifth available work point 10-5” to generate the interpolated trajectory 41 in which the task-performing part 20 may move between two available work points 10-4 and 10-5 with minimum rotation and movement. Through this, in the generated interpolated trajectory 41, the rotating operation and the joint limit of the task-performing robot may be considered, so when “a distance of a trajectory between two available work points which are close or spaced by an intermediate distance” is predicted, the distance may be predicted more accurately than the Euclidian distance. The computing device 100 may predict the distance between the available work points determined based on the plurality of candidate work trajectories generated through FIGS. 5A to 7 above and a specific process thereof will be described below through FIG. 8 below.

FIG. 8 is a schematic view for describing a process of predicting a distance between the determined available work points based on the generated plurality of candidate work trajectories according to an exemplary embodiment of the present disclosure.

According to an exemplary embodiment of the present disclosure, the computing device 100 may predict distances 50-1, 50-2, and 50-3 between the determined available work points 10-1, 10-2, 10-3, 10-4, and 10-5 based on the generated plurality of candidate work trajectories 23-2, 31, and 41 in order to distribute the target work point to the task-performing robot. In this case, the target work point may mean a point at which the task-performing robot actually performs the work among the determined available work points 10-3, 10-4, and 10-5. Meanwhile, when the target work points are distributed to the task-performing robot, in which order the work should be performed for the target work point should be determined, and this belongs to a traveling salesman problem (TSP) which is a problem of finding an order to visit all target work points at a shortest distance. Further, the computing device 100 should know a distance between the work points in order to determine a visitation order for the target work point by using a TSP solver which is already present as a known technology. For example, in the exemplary embodiment of FIG. 8, the third, fourth, and fifth available work points 10-3, 10-4, and 10-5 may be distributed to the target work point. In this case, the computing device 100 may predict the distance 50-1 between the third available work point 10-3 and the fourth available work point 10-4 based on “the candidate trajectory 31 in which the Cartesian move is possible generated through the example described in FIG. 6 above”. Further, the computing device 100 may predict the distance 50-2 between the fourth available work point 10-4 and the fifth available work point 10-5 based on “the interpolated trajectory 41 generated through the example described in FIG. 7 above”. Additionally, the computing device 100 may generate “a candidate work trajectory between the third available work point 10-3 and the fifth available work point 10-5” based on “the method for generating the interpolated trajectory 41 described in FIG. 7 above, and predict the distance 50-3 between the third available work point 10-3 and the fifth available work point 10-5 based on the generated “candidate work trajectory between the third available work point 10-3 and the fifth available work point 10-5”. Additionally, since the distance 50-1, 50-2, 50-3 between the target work points 10-3, 10-4, and 10-5 is predicted, the computing device 100 may find an order to visit all target work points at a shortest distance by using the TSP solver which is already present as known technology. In this case, since a sum of the distances 50-1 and 50-2 between the target work points 10-3, 10-4, and 10-5 is a shortest distance among combinations (in detail, a sum of two distances among the distance 50-1, the distance 50-2, or the distance 50-3) of the predicted distances, the visitation order between the target work points may be determined as an order of “third available work point 10-3→fourth available work point 10-4→fifth available work point 10-5” or “fifth available work point 10-5→fourth available work point 10-4→third available work point 10-3”. Accordingly, the computing device 100 predicts the distances 50-1, 50-2, and 50-3 between the determined available work points 10-1, 10-2, 10-3, 10-4, and 10-5 based on the generated plurality of candidate work trajectories 23-2, 31, and 41, and uses the TSP solver which is already present based on the predicted distances 50-1, 50-2, and 50-3 to easily determine the visitation order between the determined available work points. However, the target work points 10-3, 10-4, and 10-5 and the predicted distances 50-1, 50-2, and 50-3 which are examples are just examples, and are not limited thereto.

Disclosed is a computer readable medium storing the data structure according to an exemplary embodiment of the present disclosure. The data structure may refer to the organization, management, and storage of data that enables efficient access to and modification of data.

The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an availablely designed data structure, a computing device can perform operations while using the resources of the computing device to a minimum. Specifically, the computing device can increase the efficiency of operation, read, insert, delete, compare, exchange, and search through the availablely designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

In the present disclosure, a network function, an artificial neural network, and a neural network may be used to be exchangeable. From here on, it will be described uniformly using neural networks.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for training the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for training the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include training data input in a neural network training process and/or input data input to a neural network in which training is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network training process and/or a weight in which neural network training is completed. The weight which varies in the neural network training process may include a weight at a time when a training cycle starts and/or a weight that varies during the training cycle. The weight in which the neural network training is completed may include a weight in which the training cycle is completed. Accordingly, the data structure including the weight of the neural network may include a data structure including the weight which varies in the neural network training process and/or the weight in which neural network training is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of training cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

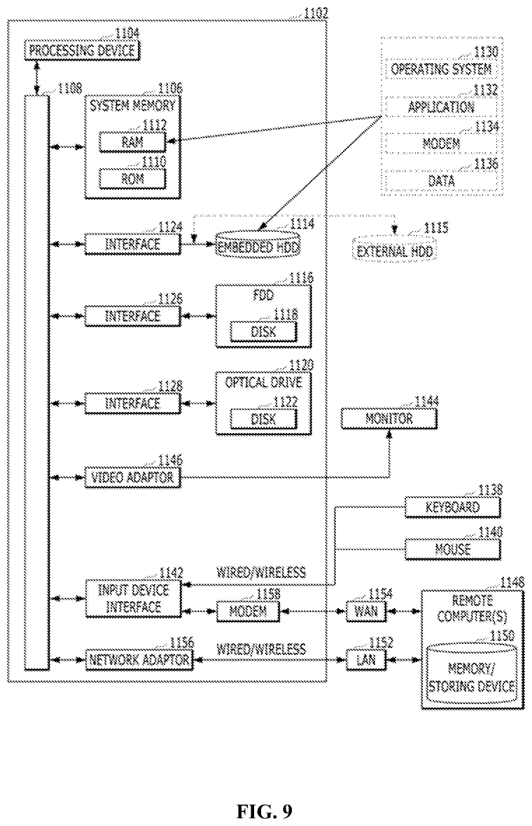

FIG. 9 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devicesas well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of anymedia among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure. Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for calculating a work trajectory of a task-performing robot, the method performed by a computing device, the method comprising:
determining available work points of a task-performing robot;
estimating whether a Cartesian move of the task-performing robot is possible for any two points among the determined available work points;
generating a plurality of candidate work trajectories for the task-performing robot based on whether the Cartesian move is possible; and
predicting a distance between the determined available work points based on the generated plurality of candidate work trajectories in order to distribute a target work point to the task-performing robot.

2. The method of claim 1, wherein the determining of the available work points of the task-performing robot comprises:
determining the available work points based on at least one of a posture, a position, or an entry of the task-performing robot.

3. The method of claim 1, wherein the estimating of whether the Cartesian move of the task-performing robot is possible for any two points among the determined available work points comprises:
estimating whether it is possible for the task-performing robot to linearly move in front/rear, up/down, or left/right directions for any two points among the determined available work points.

4. The method of claim 1, wherein the target work point is a point at which the task-performing robot actually performs work among the determined available work points.

5. A computer program stored in a non-transitory computer-readable storage medium, wherein when the computer program is executed by one or more processors, the computer program causes one or more processors to perform operations for calculating a work trajectory of a task-performing robot, the operations comprising:
an operation of determining available work points of a task-performing robot;
an operation of estimating whether a Cartesian move of the task-performing robot is possible for any two points among the determined available work points;
an operation of generating a plurality of candidate work trajectories for the task-performing robot based on whether the Cartesian move is possible; and
an operation of predicting a distance between the determined available work points based on the generated plurality of candidate work trajectories in order to distribute a target work point to the task-performing robot.

6. The computer program of claim 5, wherein the determining of the available work points of the task-performing robot comprises:
determining the available work points based on at least one of a posture, a position, or an entry of the task-performing robot.

7. The computer program of claim 5, wherein the estimating of whether the Cartesian move of the task-performing robot is possible for any two points among the determined available work points comprises:
estimating whether it is possible for the task-performing robot to linearly move in front/rear, up/down, or left/right directions for any two points among the determined available work points.

8. The computer program of claim 5, wherein the target work point is a point at which the task-performing robot actually performs work among the determined available work points.

9. A computing device comprising:
at least one processor; and
a memory,
wherein at least one processor is configured to:
determine available work points of a task-performing robot,
estimate whether a Cartesian move of the task-performing robot is possible for any two points among the determined available work points,
generate a plurality of candidate work trajectories for the task-performing robot based on whether the Cartesian move is possible, and
predict a distance between the determined available work points based on the generated plurality of candidate work trajectories in order to distribute a target work point to the task-performing robot.

10. The computing device of claim 9, wherein the determining of the available work points of the task-performing robot comprises:
determining the available work points based on at least one of a posture, a position, or an entry of the task-performing robot.

11. The computing device of claim 9, wherein the estimating of whether the Cartesian move of the task-performing robot is possible for any two points among the determined available work points comprises:
estimating whether it is possible for the task-performing robot to linearly move in front/rear, up/down, or left/right directions for any two points among the determined available work points.

12. The computing device of claim 9, wherein the target work point is a point at which the task-performing robot actually performs work among the determined available work points.
